(19) United States
(12) Patent Application Publication
(10) Pub. No.: US 2025/0232425 A1
(43) Pub. Date: Jul. 17, 2025

(54) COATING CONTINUITY TESTING DRONE

(71) Applicant: SAUDI ARABIAN OIL COMPANY, Dhahran (SA)

(72) Inventors: Rami A. Alsulaim, Al Khobar (SA); Abdulrahman M. Mukhtar, Al Khobar (SA); Khalid H. Alsubaie, Al Khobar (SA); Abdulraham A. Almulhem, Dammam (SA)

(73) Assignee: SAUDI ARABIAN OIL COMPANY, Dhahran (SA)

(21) Appl. No.: 18/415,078

(22) Filed: Jan. 17, 2024

(51) Int. Cl. G06T 7/00; B05C 9/10; B64U 80/30; B64U 101/30

(52) U.S. Cl. CPC G06T 7/0004; B05C 9/10; B64U 80/30; B64U 2101/30; B64U 2201/20; G06T 2207/20081; G06T 2207/20084

(57) ABSTRACT

System and method for inspecting an equipment structure including dispatching an unmanned aerial vehicle (UAV) to a desired location on the equipment structure, collecting a visual image, and measuring continuity readings representing a condition of the equipment structure. The continuity testing device includes an electric brush. The method further includes receiving the continuity readings and the visual image, via communicably connecting a computer processor in a pilot testing pit to the UAV, determining an analysis of the desired location identifying a coating defect and a defect type, and inputting the analysis into an artificial intelligence model. The method further includes producing a verification assessment of the plurality of continuity readings and an enhanced testing technique based on the analysis and spraying, using a marker spray coupled to the electric brush, an area of concern at the desired location.

### BACKGROUND

Oil and gas facilities require frequent inspection in order to ensure the integrity of equipment structures and safe work practices. Equipment structures, such as pipelines, pressure vessels, and storage tanks, are coated and the quality of coating is inspected by continuity testing. Holiday testing or coating continuity testing is performed on equipment to measure current flow between two points and detect local degradation of coating. However, accessing equipment structures in the oil and gas facilities is becoming more difficult due to their various heights and sizes. The major challenge in the ongoing inspection program is the inspection of out-of-reach locations of the equipment structures. Defective coating are subject to be affected by localized corrosion.

The conventional way to inspect the out-of-reach locations is to erect scaffolding in order to give the inspector access to these out-of-reach locations to perform continuity testing using a continuity testing device connected to handheld device. Inspecting out-of-reach locations by erecting the scaffold incurs high cost and longtime delay to conduct the required inspection. Furthermore, a challenge in the ongoing inspection program is lack of a verification assessment that provides confirmation of successful completion of inspection test and enhancements to the inspection tests.

### SUMMARY

This summary is provided to introduce a selection of concepts that are further described below in the detailed description. This summary is not intended to identify key or essential features of the claimed subject matter, nor is it intended to be used as an aid in limiting the scope of the claimed subject matter.

In one aspect, embodiments disclosed herein relate to a system for inspecting an equipment structure, comprising: an unmanned aerial vehicle (UAV) configured to acquire a visual image upon arriving at a desired location of the equipment structure; a continuity testing device disposed on the UAV comprising an electric brush configured to measure a plurality of continuity readings representing a condition of the equipment structure at the desired location; a marker spray coupled to the electric brush configured to spray an area of concern at the desired location based, at least in part, on the visual image and the plurality of continuity readings; and a pilot testing pit comprising a computer processor communicably connected to the UAV, wherein the pilot testing pit is configured to perform a method comprising: receiving, by the computer processor, the plurality of continuity readings and the visual image regarding the desired location; determining, by the computer processor and based on the plurality of continuity readings and the visual image, an analysis of the desired location identifying a coating defect and a defect type; inputting the analysis into an artificial intelligence model; and producing, by the computer processor, a verification assessment of the plurality of continuity readings and an enhanced testing technique based on the analysis.

In one aspect, embodiments disclosed herein relate to a method for inspecting an equipment structure, comprising: dispatching an unmanned aerial vehicle (UAV) to a desired location on the equipment structure; collecting a visual image using the UAV once the UAV has reached the desired location; measuring, using a continuity testing device disposed on the UAV, a plurality of continuity readings representing a condition of the equipment structure at the desired location, wherein the continuity testing device comprises an electric brush; receiving the plurality of continuity readings and the visual image, via communicably connecting a computer processor in a pilot testing pit to the UAV; determining, by the computer processor and based on the plurality of continuity readings and the visual image, an analysis of the desired location identifying a coating defect and a defect type; inputting the analysis into an artificial intelligence model; producing, by the computer processor, a verification assessment of the plurality of continuity readings and an enhanced testing technique based on the analysis; and spraying, using a marker spray coupled to the electric brush, an area of concern at the desired location based, at least in part, on the plurality of continuity readings and the visual image.

Other aspects and advantages of the claimed subject matter will be apparent from the following description and the appended claims.

### BRIEF DESCRIPTION OF DRAWINGS

Specific embodiments of the disclosed technology will now be described in detail with reference to the accompanying figures. Like elements in the various figures are denoted by like reference numerals for consistency.

FIG. 1 shows a system in accordance with one or more embodiments.

FIG. 2 shows a schematic diagram in accordance with one or more embodiments.

FIG. 3 shows an unmanned aerial vehicle in accordance with one or more embodiments.

FIG. 4 shows a continuity testing device in accordance with one or more embodiments.

FIG. 5 shows an example of performing continuity testing of equipment in accordance with one or more embodiments.

FIG. 6 shows a flowchart in accordance with one or more embodiments.

FIG. 7 shows a system in accordance with one or more embodiments.

FIG. 8 shows a computer system in accordance with one or more embodiments.

### DETAILED DESCRIPTION

In the following detailed description of embodiments of the disclosure, numerous specific details are set forth in order to provide a more thorough understanding of the disclosure. However, it will be apparent to one of ordinary skill in the art that the disclosure may be practiced without these specific details. In other instances, well-known features have not been described in detail to avoid unnecessarily complicating the description.

Throughout the application, ordinal numbers (e.g., first, second, third, etc.) may be used as an adjective for an element (i.e., any noun in the application). The use of ordinal numbers is not to imply or create any particular ordering of the elements nor to limit any element to being only a single element unless expressly disclosed, such as using the terms “before,” “after,” “single,” and other such terminology. Rather, the use of ordinal numbers is to distinguish between the elements. By way of an example, a first element is distinct from a second element, and the first element may encompass more than one element and succeed (or precede) the second element in an ordering of elements.

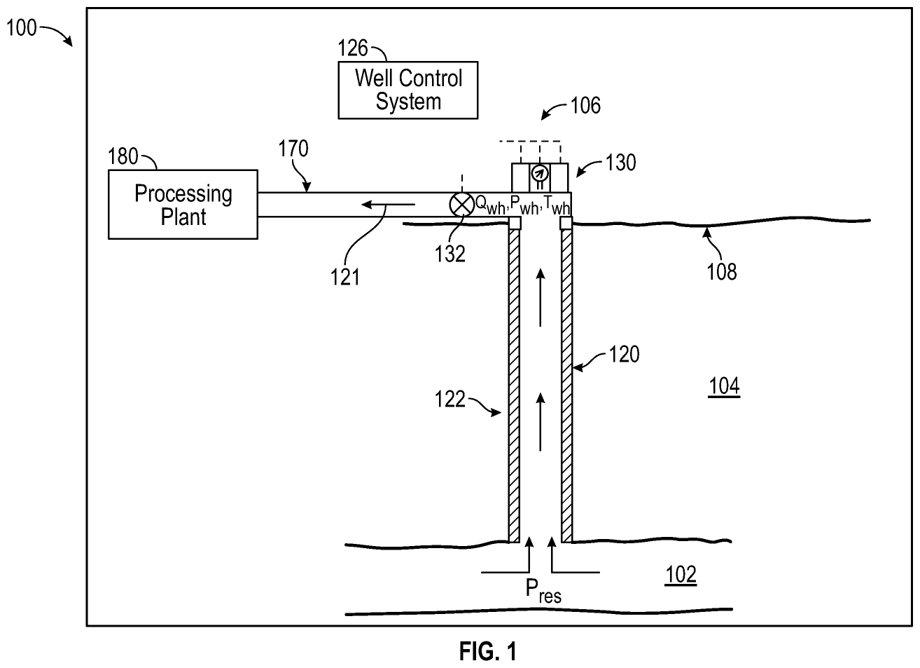

In the following description of FIGS. 1-8, any component described regarding a figure, in various embodiments disclosed herein, may be equivalent to one or more like-named components described with regard to any other figure. For brevity, descriptions of these components will not be repeated regarding each figure. Thus, each and every embodiment of the components of each figure is incorporated by reference and assumed to be optionally present within every other figure having one or more like-named components. Additionally, in accordance with various embodiments disclosed herein, any description of the components of a figure is to be interpreted as an optional embodiment which may be implemented in addition to, in conjunction with, or in place of the embodiments described with regard to a corresponding like-named component in any other figure.

It is to be understood that the singular forms “a,” “an,” and “the” include plural referents unless the context clearly dictates otherwise. Thus, for example, reference to “a force applicator” includes reference to one or more of such force applicators.

In one aspect, embodiments disclosed herein relate to a method and system for continuity testing or holiday testing of equipment structures. Continuity testing is a non-destructive testing method applied to protective coatings to detect discontinuities. Discontinuities may include but is not limited to pinholes and voids in the coating of the structure. The system and method are used to find coating film discontinuities that may not be readily visible. To perform continuity tests on the equipment structures, access to equipment structures may be difficult or unfeasible due to the equipment structures being of various heights and sizes. Conventional methods of continuity testing for elevated areas involve using a hand-held device by an inspector utilizing a scaffold or man-basket. In one or more embodiments, an unmanned aerial vehicle (UAV) or drone is equipped with a continuity testing device for accessibility to inspect elevated areas of an equipment structure. Utilizing this system increases workplace safety, reduces the amount of labor required, and eliminates the use of scaffolding or man-baskets resulting in cost savings.

In general, embodiments of the disclosure include systems and method for verification assessment of continuity readings using artificial intelligence. In some embodiments, for example, various equipment structures are actively evaluated for coating integrity.

Turning to FIG. 1, FIG. 1 shows a schematic diagram of an oil and gas facility in accordance with one or more embodiments. As shown in FIG. 1, FIG. 1 illustrates a well environment (100) that includes a hydrocarbon reservoir (“reservoir”) (102) located in a subsurface hydrocarbon-bearing formation (“formation”) (104) and a well system (106). The hydrocarbon-bearing formation (104) may include a porous or fractured rock formation that resides underground, beneath the earth's surface (“surface”) (108). In the case of the well system (106) being a hydrocarbon well, the reservoir (102) may include a portion of the hydrocarbon-bearing formation (104). The hydrocarbon-bearing formation (104) and the reservoir (102) may include different layers of rock having varying characteristics, such as varying degrees of permeability, porosity, capillary pressure, and resistivity. In the case of the well system (106) being operated as a production well, the well system (106) may facilitate the extraction of hydrocarbons (or “production”) from the reservoir (102). The well system (106) may be part of a production system that further includes a pipeline network (170) and a processing plant (180) for transporting and processing the hydrocarbons, i.e., production from the reservoir (102).

In some embodiments, the well system (106) includes a wellbore (120), a well sub-surface system (122), and a well control system (“control system”) (126). The control system (126) may control various operations of the well system (106), such as well production operations, well completion operations, well maintenance operations, and reservoir monitoring, assessment and development operations. In some embodiments, the control system (126) includes a computer system.

The wellbore (120) may include a bored hole that extends from the surface (108) into a target zone of the hydrocarbon-bearing formation (104), such as the reservoir (102). An upper end of the wellbore (120), terminating at or near the surface (108), may be referred to as the “up-hole” end of the wellbore (120), and a lower end of the wellbore, terminating in the hydrocarbon-bearing formation (104), may be referred to as the “down-hole” end of the wellbore (120). The wellbore (120) may facilitate the circulation of drilling fluids during drilling operations, the flow of hydrocarbon production (“production”) (121) (e.g., oil and gas) from the reservoir (102) to the surface (108) during production operations, the injection of substances (e.g., water) into the hydrocarbon-bearing formation (104) or the reservoir (102) during injection operations, or the communication of monitoring devices (e.g., logging tools) into the hydrocarbon-bearing formation (104) or the reservoir (102) during monitoring operations (e.g., during in situ logging operations).

Throughout this disclosure, the term “equipment structure” refers to mechanical structures of equipment and piping network. In some embodiments, the well sub-surface system (122) includes casing installed in the wellbore (120). For example, the wellbore (120) may have a cased portion and an uncased (or “open-hole”) portion. The cased portion may include a portion of the wellbore having casing (e.g., casing pipe and casing cement) disposed therein.

In some embodiments, the well system (106) includes the wellhead (130) that may include a rigid structure installed at the “up-hole” end of the wellbore (120), at or near where the wellbore (120) terminates at the Earth's surface (108). The wellhead (130) may include structures for supporting (or “hanging”) casing and production tubing extending into the wellbore (120). Production (121) may flow through the wellhead (130), after exiting the wellbore (120) and the well sub-surface system (122), including, for example, the casing and the production tubing.

In one or more embodiments, the processing plant (180) is an industrial process plant such as an oil/petroleum refinery where petroleum (crude oil) is transformed and refined, or other types of chemical processing plants. The processing plant (180) typically includes large, sprawling industrial complexes with extensive piping network running throughout, carrying streams or liquids between large chemical processing units, such as distillation columns. The piping network of processing plant facilities are applied with coating and require frequent inspection in order to ensure the quality of coating of the structure. Coating is an area of multiple examination points that may be examined during and after application to confirm quality of application. Inspecting activities may include coating continuity or holiday testing. Assets or equipment structures, such as the processing plant facility, with defected coated may be affected by localized corrosion. Accessing the processing plant structures and equipment can be difficult due to their various heights and sizes. Thus, embodiments disclosed herein are directed to testing equipment structures and pipeline networks associated with processing plants which can easily reach elevated locations for inspection activities.

While the oil and gas facilities are shown as including the well environment (100) and processing plant (180), in one or more embodiments, the oil and gas facilities may additionally or alternatively include equipment (pressure vessels), storage tanks, piping and an associated pipeline network.

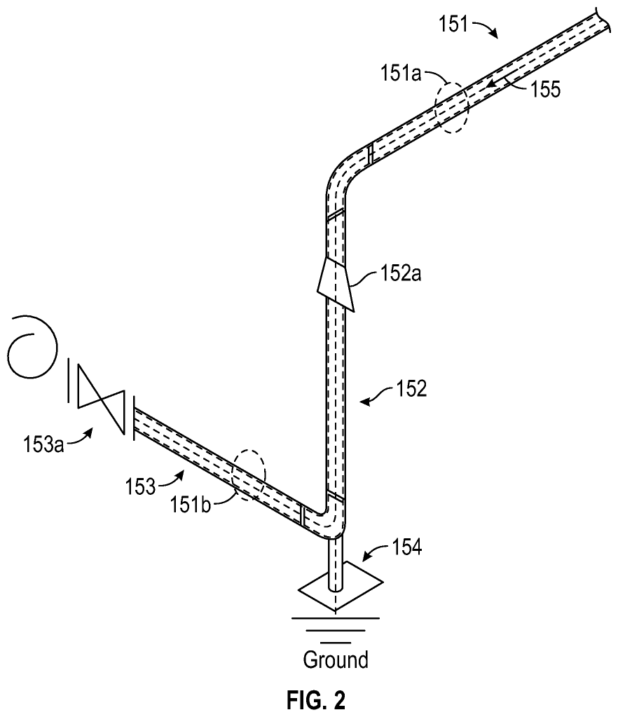

Turning to FIG. 2, FIG. 2 shows a schematic diagram in accordance with one or more embodiments. In one or more embodiments, one or more of the modules and/or elements shown in FIG. 2 may be omitted, repeated, and/or substituted. Accordingly, embodiments of the invention should not be considered limited to the specific arrangements of modules and/or elements shown in FIG. 2.

As shown in FIG. 2, FIG. 2 illustrates a portion of equipment structures installed in the well environment (100) and/or processing plant (180) depicted in FIG. 1 above. In particular, the equipment structure shown in FIG. 2 includes bent sections of a pipeline having an upper horizontal section (151) and lower horizontal section (153) that are connected via the vertical section (152). The pipeline is supported on the ground by way of a mechanical support structure (154). The lower horizontal section (153) includes a valve (153a) and the vertical section (152) includes a reducer (152a). Fluids flow through the pipeline during the on-stream condition as indicated by the arrow (155). For illustration purposes, the vertical section (152) has a length of maximum 10 meters from the ground level, rendering the upper horizontal section (152) out-of-reach for a human inspector standing on the ground. For example, a location A (151a) on the upper horizontal section (152) is an out-of-reach location. In contrast, a location B (151b) on the lower horizontal section (153) is classified as a “within-reach” for the human inspector standing on the ground.

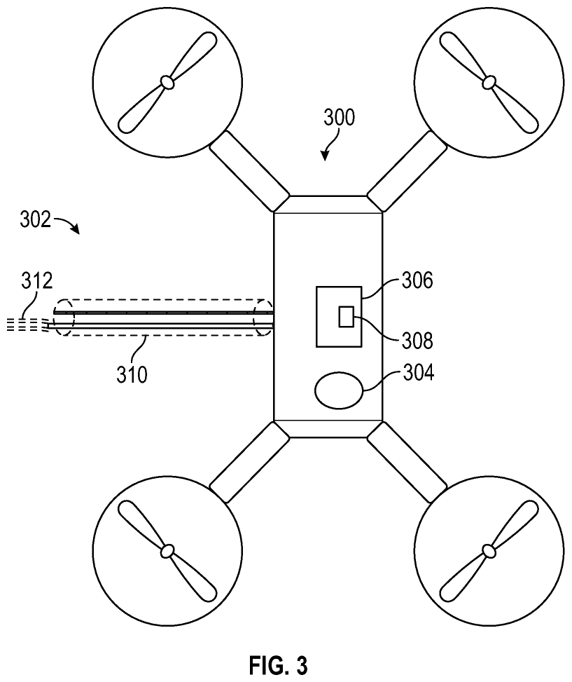

FIG. 3 shows a system in accordance with one or more embodiments. Specifically, FIG. 3 shows an unmanned aerial vehicle (UAV) (300) including a continuity testing device (302) for inspecting an equipment structure. The present disclosure places no restrictions on the type of UAV (300) employed in the system. In general, the UAV (300) may be a fix-wing type or a rotary-wing type (e.g., quadcopter, tricopter, etc.). In one or more embodiments, the UAV (300) is referred to as a “drone”. The UAV (300) may include one or more cameras (304) for acquiring one or more visual images. The UAV (300) may be flown and controlled by a user. The UAV (300) may include an electric box (306) with a battery (308) for powering the continuity testing device (302) and the UAV (300).

The continuity testing device (302) may be an online device when integrated with the UAV (300). The continuity testing device (302) may include a mechanical arm (310) holding an electric brush (312). The electric brush (312) may be a testing brush. The electric brush (312) measures a plurality of continuity readings when in contact with an equipment structure. The continuity readings represent the condition of the coating on an equipment structure.

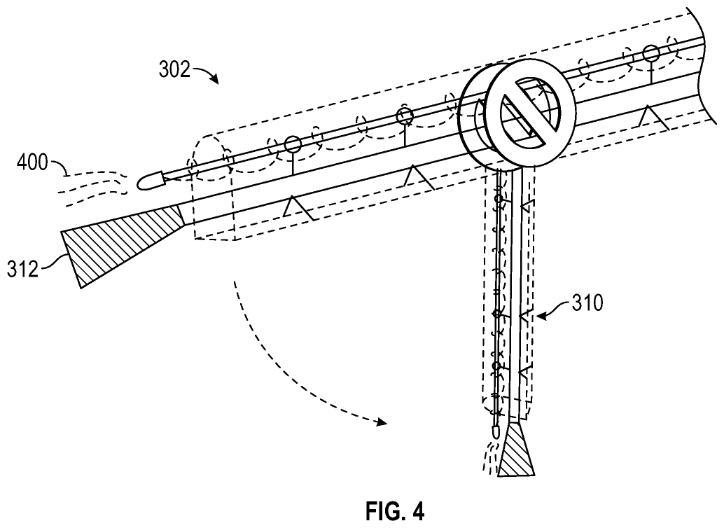

FIG. 4 shows a continuity testing device (302) in accordance with one or more embodiments. The continuity testing device (302) includes a marker spray (400) coupled to the electric brush (312). The marker spray (400) is designed to spray an area of concern to identify to a user where to re-apply coating on the equipment structure. The marker spray (400) includes a spray that is a different color than the equipment structure being inspected. In one or more embodiments, as shown by the arrow, the mechanical arm (310) on the continuity testing device (302) has the mobility to adjust the angle of the electric brush (312) and marker spray (400). The electric brush (312) and marker spray (400) may receive power from the battery (308) in the electric box (306). The electric brush (312) may be 20 centimeters in length.

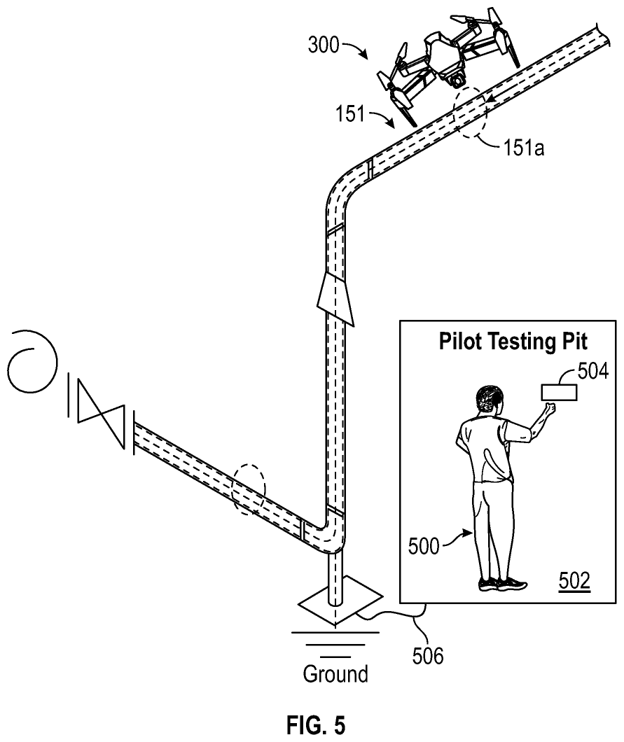

FIG. 5 shows a system for inspecting an equipment structure in accordance with one or more embodiments. The system includes a UAV (300), a continuity device (302), and a pilot testing pit (502). Specifically, FIG. 5 shows an inspector (500) controlling a UAV (300) with a continuity device (302) to engage the continuity device (302) onto the out-of-reach location A (151a) on a die wall of the upper horizontal section (151) of the equipment structure. The UAV (300) and continuity testing device (302) may be controlled by a controller (504) or remote by the inspector (500) utilizing an electrical signal. The controller (504) may include software and/or hardware with one or more buttons to control the UAV (300) and continuity testing device (302). The inspector (500) may be a pilot in the pilot testing pit (502) for the UAV (300). The UAV (300) may be controlled from the pilot testing pit (502).

The camera (304) may be used to guide the UAV (300) onto the out-of-reach location A (151a). As illustrated in FIG. 5, once the UAV (300) lands on a desired location (e.g., location A (151a)), the electric brush (312) brushes the location A (151a) and the continuity testing device (302) measures a plurality of continuity readings. For example, the continuity testing device (302) applies an electric current to the protective coating of the equipment structure to check if current can flow between two points to complete an electric circuit. A grounding mechanism source including a wire (506) may be integrated into the system. The wire (506) may be bonded from the pilot testing pit (502) to the ground of the equipment structure. The continuity readings represent the condition of the coating at the location A (151a). The continuity readings may be transmitted in real time to the pilot testing pit (502) for storage as a flight log and verification. It is critical that continuity readings be taken at several locations to confirm the quality of coating application.

The UAV (300) aids in accessibility of measuring continuity readings at multiple locations on the equipment structure. The continuity readings may be conducted based on periodical frequency. If the continuity readings indicate a discontinuity, the UAV (300) generates a visual image to identify the exact location for the area of concern. The inspector (500) may then press a button on the controller (504) to actuate the marker spray (400) to spray at the area of concern. The area of concern is an identified defected area which requires a mitigation action. Mitigation actions may include reapplication of coating to the identified coated defected area that has been sprayed by the marker spray (400). In one or more embodiments, an alarm system is used to transmit an alarm to notify a user or inspector (500) when a discontinuity is detected.

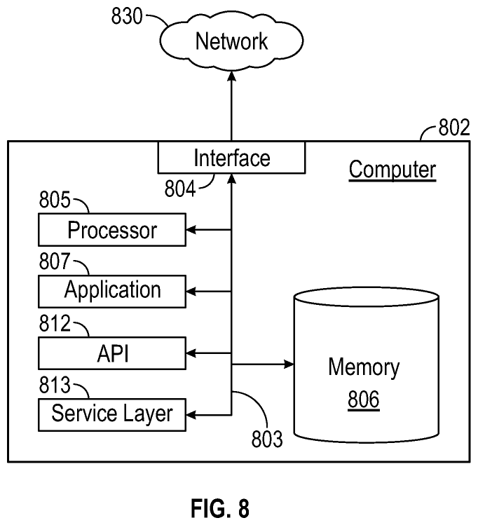

The UAV (300) acquires one or more visual images upon arrived to the location A (151a). The visual images may be 4K images and/or 4K videos. In some embodiments, the inspector (500) utilizes the UAV (300) to ensure that continuity readings are measured at correct locations in order to have an accurate assessment. The visual images along with the continuity readings are transmitted to the pilot testing pit (502). While the pilot testing pit (502) is shown at a site of the equipment structure, embodiments are contemplated the pilot testing pit (502) is located away from the site. The pilot testing pit (502) includes a computer processor that is the same or similar to the computer system (802) described below in FIG. 8 and the accompanying description. The computer processor is communicably connected to the UAV (300). The pilot testing pit (502) determines an analysis of the location A (151a) based on the continuity readings and the visual images. The analysis identifies coating defects and defect types for the location A (151a). The pilot testing pit (502) uses an artificial intelligence to produce a verification assessment and enhanced testing techniques. The verification assessment may include verifying the accuracy of the continuity readings to confirm successful completion of the inspection test.

In one or more embodiments, the inspector (500) and/or pilot has an examination process including the following steps:
Ensure all approvals are received to fly the UAV (300) as well as Job Safety Analysis Form is finalized.
Perform UAV (300) safety startup checks.
Calibrate the continuity testing device (302) before beginning the test.
Check the memory of the continuity testing device (302) to record and transfer continuity readings.
Navigate the UAV (300) to approach the desired location (e.g., location A (151a)).
Once the electric brush (312) is in contact with the desired location, ensure the continuity readings are valid and obtained before navigating the UAV (300) away.
Repeat the process until the battery (308) is drained. Calibration is performed at all battery (308) changes.
Close memory batch once each location is tested.
UAV (300) and manual memory batches are uploaded to the flight logs to secure data repository and are available for download by the pilot testing pit (502).

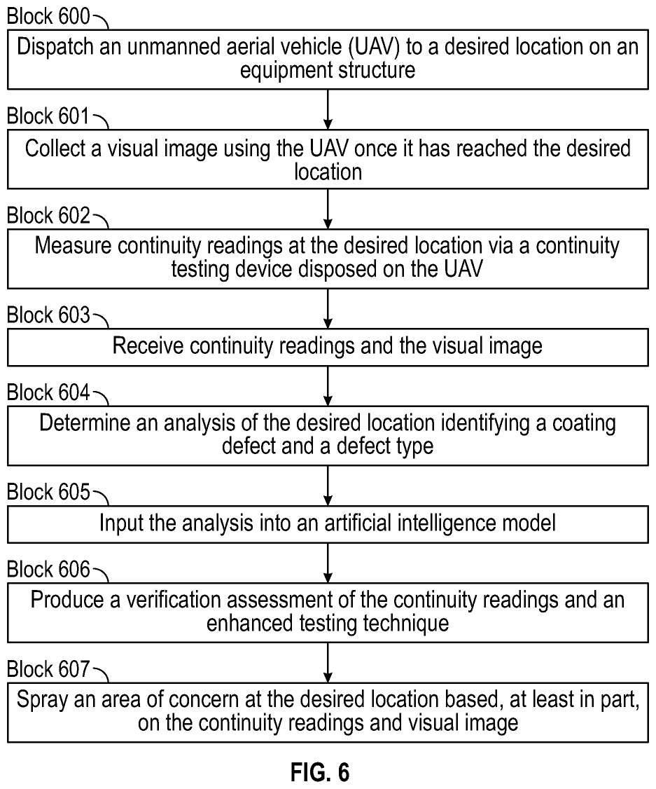

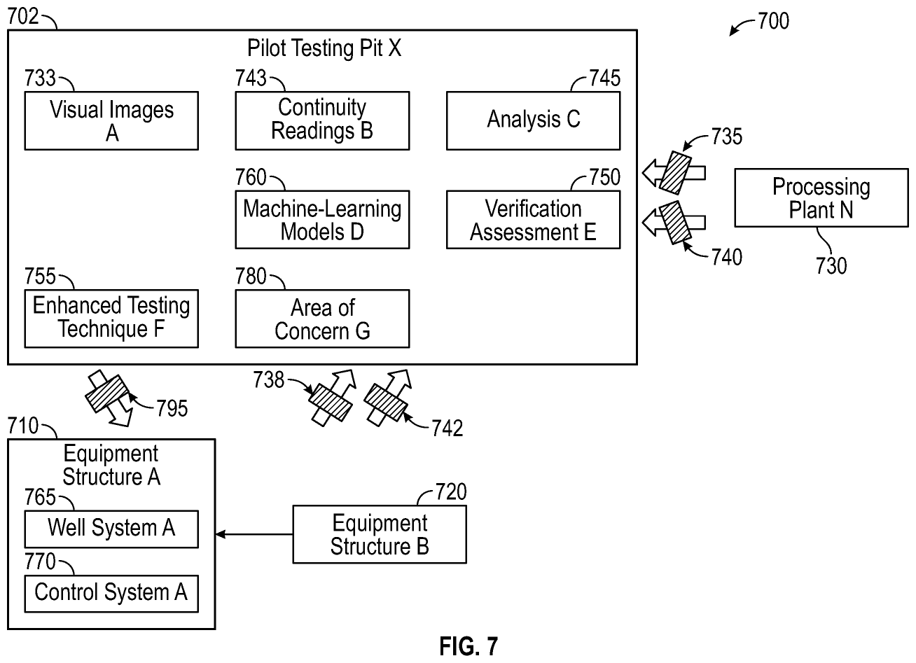

Turning to FIG. 6, FIG. 6 shows a flowchart in accordance with one or more embodiments. Specifically, FIG. 6 describes a general method for performing continuity testing of equipment structures and/or implementing maintenance operations on the equipment structures in accordance with one or more embodiments. One or more blocks in FIG. 6 may be performed by one or more components (e.g., pilot testing pit X (702)) as described in FIG. 7. While the various blocks in FIG. 6 are presented and described sequentially, one of ordinary skill in the art will appreciate that some or all of the blocks may be executed in different orders, may be combined or omitted, and some or all of the blocks may be executed in parallel. Furthermore, the blocks may be performed actively or passively.

In Block 600, an unmanned aerial vehicle (UAV) is dispatched to a desired location on an equipment structure. The UAV may be powered using an electric box including a battery disposed on the UAV. The UAV may be flown by a user in the pilot testing pit. In Block 601, a visual image is collected using the UAV once it has reached the desired location. The visual image may be a 4K image and/or 4K video. In Block 602, a plurality of continuity readings are measured at the desired location via a continuity testing device disposed on the UAV. The continuity readings represent a condition of the equipment structure at the desired location. The continuity testing device includes an electric brush. The continuity testing device is powered by the electric box and batter on the UAV. The UAV may be grounded using a grounding wire bonding the pilot testing pit to the equipment structure.

In Block 603, continuity readings and the visual image are received. A computer processor in the pilot testing pit is communicably connected to the UAV to receive the continuity readings and visual image. In Block 604, an analysis of the desired location identifying a coating defect and defect type is determined. The computer processor determined the analysis based on the continuity readings and the visual image. In Block 605, the analysis is inputted into an artificial intelligence model. The artificial intelligence model may include a machine-learning model. The machine-learning model may be a neural network.

In Block 606, a verification assessment of the continuity readings and an enhanced testing technique is produced. The computer processor produces the verification assessment and enhanced testing technique based on the analysis. In Block 607, an area of concern at the desired location is sprayed based, at least in part, on the continuity readings and visual image. The spray may include a color different from the equipment structure. The area of concern is sprayed using a marker spray coupled to the electric brush on the continuity testing device. Spraying the area of concern may identify an identified coating defected area on the equipment structure which requires a mitigation action. The identified coating defected area may be resolved by applying the mitigation action. The mitigation action may include reapplying a coating to the identified coating defected area.

Turning to FIG. 7, FIG. 7 shows a schematic diagram in accordance with one or more embodiments. In general, embodiments of the disclosure include a method for the pilot testing pit (502). As shown in FIG. 1, an oil and gas system (e.g., well environment (700)) may include various equipment structures (e.g., equipment structure A (710), equipment structure B (720)), various processing plants (e.g., processing plant N (730)), various network elements (not shown), and/or a pilot testing pit (e.g., pilot testing pit X (702)). In some embodiments, various types of testing data (e.g., visual images A (733), visual images X (735), visual images Y (738), continuity readings B (743), continuity readings X (740), continuity readings Y (742)) are collected over the oil and gas system. Likewise, the pilot testing pit may also determine an analysis (e.g., analysis C (745)) and a verification assessment (e.g., verification assessment E (750)) regarding one or more equipment structures providing well systems throughout the oil and gas system. Likewise, the pilot testing pit may also determine an enhanced testing technique (e.g., enhanced testing technique F (755)) regarding one or more equipment structures throughout the oil and gas system. The enhanced testing technique may be determined by inputting equipment structure data such as speed, contact, distance elevation, and orientation into a machine-learning model (e.g., machine-learning models D (760))

Furthermore, an equipment structure (e.g., equipment structure A (710) or equipment structure B (720)) may include a well system (e.g., well system A (765)) located in a well environment that includes a hydrocarbon reservoir (“reservoir”) located in a subsurface hydrocarbon-bearing formation. The hydrocarbon-bearing formation may include a porous or fractured rock formation that resides underground, beneath the earth's surface (“surface”). In the case of the well system being a hydrocarbon well, the reservoir may include a portion of the hydrocarbon-bearing formation. The hydrocarbon-bearing formation and the reservoir may include different layers of rock having varying characteristics, such as varying degrees of permeability, porosity, and resistivity. In the case of the well system being operated as a production well, the well system may facilitate the extraction of hydrocarbons (or “production”) from the reservoir. In some embodiments, the well system includes a wellbore, a well sub-surface system, a well surface system, and a well control system. The wellbore may include a bored hole that extends from the surface into a target zone of the hydrocarbon-bearing formation, such as the reservoir. The wellbore may facilitate the circulation of drilling fluids during drilling operations, the flow of hydrocarbon production (“production”) (e.g., oil and gas) from the reservoir to the surface during production operations, the injection of substances (e.g., water) into the hydrocarbon-bearing formation or the reservoir during injection operations, or the communication of monitoring devices (e.g., logging tools) into the hydrocarbon-bearing formation or the reservoir during monitoring operations (e.g., during in situ logging operations). A control system (e.g., control system A (770)) in a well system may control various operations of the well system, such as well production operations, well completion operations, well maintenance operations, and reservoir monitoring, assessment and development operations. In some embodiments, the control system includes a computer system that is the same as or similar to that of computer system (802) described below in FIG. 8 and the accompanying description.

With respect to distributed control systems, a distributed control system may be a computer system for managing various processes at a facility using multiple control loops. As such, a distributed control system may include various autonomous controllers (such as remote terminal units (RTUs)) positioned at different locations throughout the facility to manage operations and monitor processes. Likewise, a distributed control system may include no single centralized computer for managing control loops and other operations. On the other hand, a SCADA system may include a control system that includes functionality for enabling monitoring and issuing of process commands through local control at a facility as well as remote control outside the facility. With respect to an RTU, an RTU may include hardware and/or software, such as a microprocessor, that connects sensors and/or actuators using network connections to perform various processes in the automation system.

Keeping with control systems, a control system may be coupled to facility equipment. Facility equipment may include various machinery such as one or more hardware components, such as pipe components, that may be monitored using one or more sensors. Examples of hardware components coupled to a control system may include crude oil preheaters, heat exchangers, pumps, valves, compressors, loading racks, and storage tanks among various other types of hardware components. Hardware components may also include various network elements or control elements for implementing control systems, such as switches, routers, hubs, PLCs, remote terminal units, user equipment, or any other technical components for performing specialized processes. Examples of sensors may include pressure sensors, flow rate sensors, temperature sensors, torque sensors, rotary switches, weight sensors, position sensors, microswitches, hydrophones, accelerometers, etc. A pilot testing pit and network elements may be computer systems similar to the computer system (802) described in FIG. 8 and the accompanying description.

In some embodiments, a pilot testing pit includes functionality for determining an area of concern (e.g., (area of concern G (780)) and/or implementing one or more mitigation actions based on verification assessments and analysis. A mitigation action may include reapplying a coating to the area of concern. A mitigation action may also include replacing or retrofitting a portion of the equipment structure that is part of a well system based on the equipment structure failing to satisfy a predetermined criterion.

In some embodiments, the pilot testing pit includes functionality for transmitting commands (e.g., command Y (795)) to one or more control systems to display the schedule or implement a particular mitigation action. For example, the pilot testing pit X (702) may transmit a network message over a machine-to-machine protocol to a control system in processing plant N (730). A command may be transmitted periodically, based on user input, or automatically based on changes in continuity readings, verification assessment, analysis, visual images, and area of concern.

Continuing with FIG. 6, a pilot testing pit (e.g., a pilot testing pit X (702)) may include hardware and/or software with functionality for storing and/or using one or more machine-learning models (e.g., machine-learning models D (760)) to produce verification assessment and/or enhanced testing techniques (e.g., by inputting continuity readings and visual images to provide a verification assessment for the equipment structure).

Machine learning (ML), broadly defined, is the extraction of patterns and insights from data. The phrases “artificial intelligence,” “machine learning,” “deep learning,” and “pattern recognition” are often convoluted, interchanged, and used synonymously throughout the literature. This ambiguity arises because the field of “extracting patterns and insights from data” was developed simultaneously and disjointedly among a number of classical arts like mathematics, statistics, and computer science. For consistency, the term machine learning, or machine-learned, will be adopted herein. However, one skilled in the art will recognize that the concepts and methods detailed hereafter are not limited by this choice of nomenclature.

Machine-learned model types may include, but are not limited to, generalized linear models, Bayesian regression, support vector machines, decision trees, random forests, and deep models such as neural networks, convolutional neural networks, and recurrent neural networks. Machine-learned model types, whether they are considered deep or not, are usually associated with additional “hyperparameters” that further describe the model. For example, hyperparameters providing further detail about a neural network may include, but are not limited to, the number of layers in the neural network, choice of activation functions, inclusion of batch normalization layers, and regularization strength. Commonly, in the literature, the selection of hyperparameters surrounding a machine-learned model is referred to as selecting the model “architecture.” Once a machine-learned model type and hyperparameters have been selected, the machine-learned model is trained to perform a task. In some instances, hyperparameters of a model may be learned during a training process of the machine-learned model. In one or more embodiments, the machine-learned model type and training procedure may be categorized as a supervised learning process where instances of example inputs and labeled (or annotated) outputs are provided to the model during training. In other embodiments, the machine-learned model type and training procedure may be categorized as a semi-supervised learning process where only a portion of example inputs used in training have an associated labeled (or annotated) output. In these instances, unlabeled example inputs may be used during the training procedure. In one or more embodiments, multiple “rounds” of training may occur in order to determine an optimal set of hyperparameters and/or make use of newly labeled training data (e.g., in the case of semi-supervised learning). Once a machine-learned model is trained, it may be used in a production setting (also known as deployment of the machine-learned model). A brief description of various machine-learned models is provided below.

In a deep neural network, a layer of neurons may be trained on a predetermined list of features based on the previous network layer's output. Thus, as data progresses through the deep neural network, more complex features may be identified within the data by neurons in later layers. Likewise, a U-net model or other type of convolutional neural network model may include various convolutional layers, pooling layers, fully connected layers, and/or normalization layers to produce a particular type of output. Thus, convolution and pooling functions may be the activation functions within a convolutional neural network. In some embodiments, two or more different types of machine-learning models are integrated into a single machine-learning architecture, e.g., a machine-learning model may include K-nearest neighbor (k-NN) models and neural networks. In some embodiments, a reservoir simulator may generate augmented data or synthetic data to produce a large amount of interpreted data for training a particular model.

In some embodiments, various types of machine-learning algorithms (not shown) may be used to train the model, such as a backpropagation algorithm. In a backpropagation algorithm, gradients are computed for each hidden layer of a neural network in reverse from the layer closest to the output layer proceeding to the layer closest to the input layer. As such, a gradient may be calculated using the transpose of the weights of a respective hidden layer based on an error function (also called a “loss function”). The error function may be based on various criteria, such as mean squared error function, a similarity function, etc., where the error function may be used as a feedback mechanism for tuning weights in the machine-learning model.

In some embodiments, a machine-learning model is trained using multiple epochs. For example, an epoch may be an iteration of a model through a portion or all of a training dataset. As such, a single machine-learning epoch may correspond to a specific batch of training data, where the training data is divided into multiple batches for multiple epochs. Thus, a machine-learning model may be trained iteratively using epochs until the model achieves a predetermined criterion, such as predetermined level of prediction accuracy or training over a specific number of machine-learning epochs or iterations. Thus, better training of a model may lead to better predictions by a trained model.

With respect to support vector machines, a support vector machines may be a machine-learning model that is trained using a supervised machine-learning algorithm. For example, a support vector machine may provide a data analysis on various input features that implement a classification and regression analysis. More specifically, a support vector machine may determine a hyperplane that separates a dataset into different classes, and also determines various points (i.e., support vectors) that lie closest to different classes. Additionally, a support vector machine may use one or more kernel functions to transform data into a desired form for further processing. The term “Kernel” may refer to a set of mathematical functions that provide the window to manipulate the input data. In other words, a kernel function may transform a training set of data so that a non-linear decision surface is able to transform to a linear equation into a higher number of dimension spaces. Examples of kernel functions may include gaussian kernel functions, gaussian kernel radial basis functions (RBFs), sigmoid kernel functions, polynomial kernel functions, and linear kernel functions.

With respect to artificial neural networks, for example, an artificial neural network may include one or more hidden layers, where a hidden layer includes one or more neurons. A neuron may be a modelling node or object that is loosely patterned on a neuron of the human brain. In particular, a neuron may combine data inputs with a set of coefficients, i.e., a set of network weights for adjusting the data inputs. These network weights may amplify or reduce the value of a particular data input, thereby assigning an amount of significance to various data inputs for a task being modeled. Through machine learning, a neural network may determine which data inputs should receive greater priority in determining one or more specified outputs of the artificial neural network. Likewise, these weighted data inputs may be summed such that this sum is communicated through a neuron's activation function to other hidden layers within the artificial neural network. As such, the activation function may determine whether and to what extent an output of a neuron progresses to other neurons where the output may be weighted again for use as an input to the next hidden layer.

Turning to recurrent neural networks, a recurrent neural network (RNN) may perform a particular task repeatedly for multiple data elements in an input sequence (e.g., a sequence of temperature values or flow rate values), with the output of the recurrent neural network being dependent on past computations. As such, a recurrent neural network may operate with a memory or hidden cell state, which provides information for use by the current cell computation with respect to the current data input. For example, a recurrent neural network may resemble a chain-like structure of RNN cells, where different types of recurrent neural networks may have different types of repeating RNN cells. Likewise, the input sequence may be time-series data, where hidden cell states may have different values at different time steps during a prediction or training operation. For example, where a deep neural network may use different parameters at each hidden layer, a recurrent neural network may have common parameters in an RNN cell, which may be performed across multiple time steps. To train a recurrent neural network, a supervised learning algorithm such as a backpropagation algorithm may also be used. In some embodiments, the backpropagation algorithm is a backpropagation through time (BPTT) algorithm. Likewise, a BPTT algorithm may determine gradients to update various hidden layers and neurons within a recurrent neural network in a similar manner as used to train various deep neural networks.

Embodiments are contemplated with different types of RNNs. For example, classic RNNs, long short-term memory (LSTM) networks, a gated recurrent unit (GRU), a stacked LSTM that includes multiple hidden LSTM layers (i.e., each LSTM layer includes multiple RNN cells), recurrent neural networks with attention (i.e., the machine-learning model may focus attention on specific elements in an input sequence), bidirectional recurrent neural networks (e.g., a machine-learning model that may be trained in both time directions simultaneously, with separate hidden layers, such as forward layers and backward layers), as well as multidimensional LSTM networks, graph recurrent neural networks, grid recurrent neural networks, etc. With regard to LSTM networks, an LSTM cell may include various output lines that carry vectors of information, e.g., from the output of one LSTM cell to the input of another LSTM cell. Thus, an LSTM cell may include multiple hidden layers as well as various pointwise operation units that perform computations such as vector addition.

In some embodiments, ensemble learning methods are used to produce a hybrid-model architecture. For example, an ensemble learning method may use multiple types of machine-learning models to obtain better predictive performance than available with a single machine-learning model. In some embodiments, for example, an ensemble architecture may combine multiple base models to produce a single machine-learning model. One example of an ensemble learning method is a BAGGing model (i.e., BAGGing refers to a model that performs Bootstrapping and Aggregation operations) that combines predictions from multiple neural networks to reduce the variance of a single trained neural network model. Another ensemble learning method includes a stacking method, which may involve fitting many different model types on the same data and using another machine-learning model to combine various predictions.

Turning to random forests, a random forest model may combine the output of multiple decision trees to reach a single predicted result. For example, a random forest algorithm is made up of a collection of decision trees, where training of the random forest model determines three main hyperparameters that include node size, the number of decision trees, and the number of input features being sampled. During training, a random forest model may allow different decision trees to randomly sample from a dataset with replacement (e.g., from a bootstrap sample) to produce multiple final decision trees in the trained model. For example, when multiple decision trees form an ensemble in the random forest model, this ensemble may determine more accurate predicted data, particularly when the individual trees are uncorrelated with each other. In some embodiments, a random forest model implements a software algorithm that is an extension of a bagging method. As, a random forest model may use both bagging and feature randomness to create an uncorrelated forest of decision trees. Feature randomness (also referred to as “feature bagging”) may generate a random subset of input features. This random subject may thereby result in low correlation among decision trees in the random forest model. In a training operation for a random forest model, a training operation may search for decision trees that provide the best split to subset particular data, such as through a Classification and Regression Tree (CART) algorithm. Different metrics, such as information gain or mean square error (MSE), may be used to determine the quality of a data split.

Keeping with random forests, a random forest model may be a classifier that uses data having discrete labels or classes. Likewise, a random forest model may also be used as a random forest regressor to solve regression problems. Depending on the type of problem being addressed by the random forest model, how predicted data is determined may vary accordingly. For a regression task, the individual decision trees may be averaged in a predicted result. For a classification task, a majority vote (e.g., the most frequent categorical variable) may determine a predicted class. In a random forest regressor, the model may work with data having a numeric or continuous output, which cannot be defined by distinct classes.

While FIG. 8 shows various configurations of components, other configurations may be used without departing from the scope of the disclosure. For example, various components in FIG. 8 may be combined to create a single component. As another example, the functionality performed by a single component may be performed by two or more components.

Embodiments may be implemented on a computer system. FIG. 8 is a block diagram of a computer system (802) used to provide computational functionalities associated with described algorithms, methods, functions, processes, flows, and procedures as described in the instant disclosure, according to an implementation. The illustrated computer (802) is intended to encompass any computing device such as a high performance computing (HPC) device, a server, desktop computer, laptop/notebook computer, wireless data port, smart phone, personal data assistant (PDA), tablet computing device, one or more processors within these devices, or any other suitable processing device, including both physical or virtual instances (or both) of the computing device. Additionally, the computer (802) may include a computer that includes an input device, such as a keypad, keyboard, touch screen, or other device that can accept user information, and an output device that conveys information associated with the operation of the computer (802), including digital data, visual, or audio information (or a combination of information), or a GUI.

The computer (802) can serve in a role as a client, network component, a server, a database or other persistency, or any other component (or a combination of roles) of a computer system for performing the subject matter described in the instant disclosure. The illustrated computer (802) is communicably coupled with a network (830). In some implementations, one or more components of the computer (802) may be configured to operate within environments, including cloud-computing-based, local, global, or other environment (or a combination of environments).

At a high level, the computer (802) is an electronic computing device operable to receive, transmit, process, store, or manage data and information associated with the described subject matter. According to some implementations, the computer (802) may also include or be communicably coupled with an application server, e-mail server, web server, caching server, streaming data server, business intelligence (BI) server, or other server (or a combination of servers).

The computer (802) can receive requests over network (830) from a client application (for example, executing on another computer (802)) and responding to the received requests by processing the said requests in an appropriate software application. In addition, requests may also be sent to the computer (802) from internal users (for example, from a command console or by other appropriate access method), external or third-parties, other automated applications, as well as any other appropriate entities, individuals, systems, or computers.

Each of the components of the computer (802) can communicate using a system bus (803). In some implementations, any or all of the components of the computer (802), both hardware or software (or a combination of hardware and software), may interface with each other or the interface (804) (or a combination of both) over the system bus (803) using an application programming interface (API) (812) or a service layer (813) (or a combination of the API (812) and service layer (813). The API (812) may include specifications for routines, data structures, and object classes. The API (812) may be either computer-language independent or dependent and refer to a complete interface, a single function, or even a set of APIs. The service layer (813) provides software services to the computer (802) or other components (whether or not illustrated) that are communicably coupled to the computer (802). The functionality of the computer (802) may be accessible for all service consumers using this service layer. Software services, such as those provided by the service layer (813), provide reusable, defined business functionalities through a defined interface. For example, the interface may be software written in JAVA, C++, or other suitable language providing data in extensible markup language (XML) format or other suitable format. While illustrated as an integrated component of the computer (802), alternative implementations may illustrate the API (812) or the service layer (813) as stand-alone components in relation to other components of the computer (802) or other components (whether or not illustrated) that are communicably coupled to the computer (802). Moreover, any or all parts of the API (812) or the service layer (813) may be implemented as child or sub-modules of another software module, enterprise application, or hardware module without departing from the scope of this disclosure.

The computer (802) includes an interface (804). Although illustrated as a single interface (804) in FIG. 8, two or more interfaces (804) may be used according to particular needs, desires, or particular implementations of the computer (802). The interface (804) is used by the computer (802) for communicating with other systems in a distributed environment that are connected to the network (830). Generally, the interface (includes logic encoded in software or hardware (or a combination of software and hardware) and operable to communicate with the network (830). More specifically, the interface (804) may include software supporting one or more communication protocols associated with communications such that the network (830) or interface's hardware is operable to communicate physical signals within and outside of the illustrated computer (802).

The computer (802) includes at least one computer processor (805). Although illustrated as a single computer processor (805) in FIG. 8, two or more processors may be used according to particular needs, desires, or particular implementations of the computer (802). Generally, the computer processor (805) executes instructions and manipulates data to perform the operations of the computer (802) and any algorithms, methods, functions, processes, flows, and procedures as described in the instant disclosure.

The computer (802) also includes a memory (806) that holds data for the computer (802) or other components (or a combination of both) that can be connected to the network (830). For example, memory (806) can be a database storing data consistent with this disclosure. Although illustrated as a single memory (806) in FIG. 8, two or more memories may be used according to particular needs, desires, or particular implementations of the computer (802) and the described functionality. While memory (806) is illustrated as an integral component of the computer (802), in alternative implementations, memory (806) can be external to the computer (802).

The application (807) is an algorithmic software engine providing functionality according to particular needs, desires, or particular implementations of the computer (802), particularly with respect to functionality described in this disclosure. For example, application (807) can serve as one or more components, modules, applications, etc. Further, although illustrated as a single application (807), the application (807) may be implemented as multiple applications (807) on the computer (802). In addition, although illustrated as integral to the computer (802), in alternative implementations, the application (807) can be external to the computer (802).

There may be any number of computers (802) associated with, or external to, a computer system containing computer (802), each computer (802) communicating over network (830). Further, the term “client,” “user,” and other appropriate terminology may be used interchangeably as appropriate without departing from the scope of this disclosure. Moreover, this disclosure contemplates that many users may use one computer (802), or that one user may use multiple computers (802).

In some embodiments, the computer (802) is implemented as part of a cloud computing system. For example, a cloud computing system may include one or more remote servers along with various other cloud components, such as cloud storage units and edge servers. In particular, a cloud computing system may perform one or more computing operations without direct active management by a user device or local computer system. As such, a cloud computing system may have different functions distributed over multiple locations from a central server, which may be performed using one or more Internet connections. More specifically, cloud computing system may operate according to one or more service models, such as infrastructure as a service (IaaS), platform as a service (PaaS), software as a service (SaaS), mobile “backend” as a service (MBaaS), serverless computing, artificial intelligence (AI) as a service (AIaaS), and/or function as a service (FaaS).

Although only a few example embodiments have been described in detail above, those skilled in the art will readily appreciate that many modifications are possible in the example embodiments without materially departing from this invention. Accordingly, all such modifications are intended to be included within the scope of this disclosure as defined in the following claims.

What is claimed is:

1. A system for inspecting an equipment structure, comprising:
an unmanned aerial vehicle (UAV) configured to acquire a visual image upon arriving at a desired location of the equipment structure;
a continuity testing device disposed on the UAV comprising an electric brush configured to measure a plurality of continuity readings representing a condition of the equipment structure at the desired location;
a marker spray coupled to the electric brush configured to spray an area of concern at the desired location based, at least in part, on the visual image and the plurality of continuity readings; and
a pilot testing pit comprising a computer processor communicably connected to the UAV, wherein the pilot testing pit is configured to perform a method comprising:
receiving, by the computer processor, the plurality of continuity readings and the visual image regarding the desired location;
determining, by the computer processor and based on the plurality of continuity readings and the visual image, an analysis of the desired location identifying a coating defect and a defect type;
inputting the analysis into an artificial intelligence model; and
producing, by the computer processor, a verification assessment of the plurality of continuity readings and an enhanced testing technique based on the analysis.

2. The system of claim 1, further comprising:
an electric box disposed on the UAV comprising a battery configured to power the continuity testing device and the UAV.

3. The system of claim 1, further comprising:
a grounding wire bonding the pilot testing pit to the equipment structure.

4. The system of claim 1,
wherein the visual image comprises a 4K image.

5. The system of claim 1,
wherein the visual image comprises a 4K video.

6. The system of claim 1,
wherein the artificial intelligence model comprises a machine-learning model, the machine-learning model comprising a neural network.

7. The system of claim 1,
wherein the UAV is flown by a user in the pilot testing pit.

8. The system of claim 1,
wherein the area of concern comprises an identified coating defected area requiring a mitigation action.

9. The system of claim 8,
wherein the mitigation action comprises a reapplication of coating to the identified coating defected area.

10. The system of claim 1,
wherein the marker spray comprises a color different from the equipment structure.

11. A method for inspecting an equipment structure, comprising:
dispatching an unmanned aerial vehicle (UAV) to a desired location on the equipment structure;
collecting a visual image using the UAV once the UAV has reached the desired location;
measuring, using a continuity testing device disposed on the UAV, a plurality of continuity readings representing a condition of the equipment structure at the desired location,
wherein the continuity testing device comprises an electric brush;
receiving the plurality of continuity readings and the visual image, via communicably connecting a computer processor in a pilot testing pit to the UAV;
determining, by the computer processor and based on the plurality of continuity readings and the visual image, an analysis of the desired location identifying a coating defect and a defect type;
inputting the analysis into an artificial intelligence model;
producing, by the computer processor, a verification assessment of the plurality of continuity readings and an enhanced testing technique based on the analysis; and
spraying, using a marker spray coupled to the electric brush, an area of concern at the desired location based, at least in part, on the plurality of continuity readings and the visual image.

12. The method of claim 11, further comprising:
powering the continuity testing device and the UAV via an electric box comprising a battery disposed on the UAV.

13. The method of claim 11, further comprising:
grounding the UAV via a grounding wire bonding the pilot testing pit to the equipment structure.

14. The method of claim 11,
wherein collecting the visual image comprises collecting a 4K image.

15. The method of claim 13,
wherein collecting the visual image comprises collecting a 4K video.

16. The method of claim 11,
wherein the artificial intelligence model comprises a machine-learning model, the machine-learning model comprising a neural network.

17. The method of claim 11, further comprising:
flying the UAV via a user in the pilot testing pit.

18. The method of claim 11,
wherein spraying the area of concern comprises identifying an identified coating defected area requiring a mitigation action.

19. The method of claim 18,
resolving the identified coating defected area by applying the mitigation action,
wherein applying the mitigation action comprises reapplying a coating to the identified coating defected area.

20. The method of claim 11,
wherein spraying the area of concern comprises spraying a color different from the equipment structure.
